(19) United States
(12) Patent Application Publication
(10) Pub. No.: US 2005/0281532 A1
(43) Pub. Date: Dec. 22, 2005

(54) Data record/reproduction device capable of continuous record and/or reproduction of picture data

(75) Inventor: Hiroshi Nishigaki, Osaka (JP)

Correspondence Address: OSHA LIANG L.L.P., 1221 MCKINNEY STREET, SUITE 2800, HOUSTON, TX, 77010, US

(73) Assignee: Funai Electric Co., Ltd., Osaka (JP)

(21) Appl. No.: 11/153,881

(22) Filed: Jun. 15, 2005

(30) Foreign Application Priority Data
Jun. 16, 2004 (JP) 2004-178698

(51) Int. Cl. H04N 5/76; H04N 5/781

(52) U.S. Cl. 386/46; 386/125

(57) ABSTRACT

A data record/reproduction device for continuously recording and/or reproducing a picture is provided. Record processing executed by a system control circuit achieved by a DVD recorder provided with record mediums A and B includes a step of storing information of “presence of subsequent record A” in a management data record region of the record medium A after the end of recording on the record medium A if a time required before the end of programmed recording is equal to or longer than a time available before recording on the record medium A; a step of storing an address of picture data to be recorded in a management data storing region of record medium B; and a step of recording a picture in a picture data storage region of record medium B until an end time.

### BACKGROUND OF THE INVENTION

1. Field of the Invention

The present invention relates to a technology of recording and reproducing picture data, and particularly to a record/reproduction device having a function of recording picture data on a plurality of record mediums.

2. Description of the Background Art

Some kinds of image data record/reproduction devices such as a VTR (Video Tape Recorder) and a so-called hard disk recorder are internally provided with, e.g., a combination of a video tape and a hard disk, or a combination of a DVD (Digital Versatile Disk) and a hard disk. When long-time TV programs or the like are to be recorded by these devices, such a situation may occur that one record medium such as a video tape or a DVD cannot store the entire picture, and a second record medium (e.g., a hard disk) records a subsequent portion. For reproducing the picture stored on the different record mediums, a user must locate the start of the picture on the second record medium for reproducing the subsequent picture portion. For example, Japanese Patent Laying-Open Nos. 08-098122 and 2002-334558 have disclosed techniques, in which a picture is stored in a plurality of record mediums, and can be continuously reproduced therefrom.

According to a picture accumulating method and a picture reproducing method disclosed in Japanese Patent Laying-Open No. 08-098122, since a picture stored on an nth record medium and a picture stored on an (n+1)th record medium are joined by a picture stored in the nth or (N+1)th record medium, and these pictures can be continuously reproduced without an interruption.

An image record/reproduction device disclosed in Japanese Patent Laying-Open No. 2002-334558 can continuously reproduce the picture based on table information prepared based on preselected or programmed record information.

In the picture accumulating method and picture reproducing method disclosed in Japanese Patent Laying-Open No. 08-098122, however, the picture for joining the pictures must be stored, and this reduces an available capacity of the record medium,

Further, in the picture record/reproduction device disclosed in Japanese Patent Laying-Open No. 2002-334558, a data region is required for holding the table information prepared based on the programmed record information.

The invention has been developed for overcoming the above problems, and an object of the invention is to provide a data record/reproduction device, which allows continuous reproduction while suppressing consumption of a capacity of a record medium.

Another object of the invention is to provide a data record/reproduction device, which allows continuous recording and reproducing of data without requiring a user's operation.

### SUMMARY OF THE INVENTION

For achieving the objects, a data record/reproduction device according to an aspect of the invention includes first and second recording units for storing data; a first writing unit writing the data to the first recording unit; a first reproducing unit reading the data from the first recording unit; a second writing unit writing the data to the second recording unit; a second reproducing unit reading the data from the second recording unit; a record information recording unit storing record information; a determining unit determining based on the record information whether or not the data must be recorded on both the first and second recording units; a first continuous record control unit controlling the first and second writing units to write control data representing continuous recording of the data to the first and second recording units when the determining unit determines that both the recording units must record the data; a second continuous record control unit controlling the first and second writing units to record continuously the data in the first and second recording units when the determining unit determines that the data must be recorded in both the first and second recording units; and a continuous reproducing unit controlling the first and second reproducing units to reproduce continuously the data based on the control data.

Preferably, the determining unit includes a first calculating unit calculating a capacity available for recording the data by the first recording unit based on the record information, a second calculating unit calculating a capacity required for recording the data based on the record information, and a comparing unit comparing the capacity available for the recording and the required capacity. The first continuous record control unit includes a first write control unit controlling the first writing unit to store first record information representing continuous storage of the data in the second recording unit in a predetermined region of the first recording unit when the capacity required for the recording exceeds the capacity available for the recording, and a second write control unit controlling the second writing unit to store second record information representing a storage location of the data continued from the data stored in the first recording unit in the second recording unit. The second continuous record control unit includes a record control unit switching a data record destination based on the record information between the first and second recording units based on the capacity required for the recording and the capacity available for the recording. The continuous reproducing unit includes a reproduction control unit controlling the first and second reproducing units to reproduce continuously the data stored in the first and second reproducing units based on the first and second record information, respectively.

Preferably, when the capacity required for the recording exceeds the capacity available for the recording, the record control unit switches the record destination of the picture data based on the record information from the first recording unit to the second recording unit.

Preferably, the record control unit controls the second writing unit to store the picture data in the second recording unit subsequently to the recording of the picture data in the first recording unit by the first writing unit.

Preferably, the reproduction control unit controls the second reproducing unit to reproduce the data subsequently to the reproduction by the first reproducing unit based on the second record information when the reproduction control unit detects the first record information during reproduction of the data by the first reproducing unit.

Preferably, the first calculating unit calculates, as the capacity, a time available for recording the picture data in the first recording unit. The second calculating unit calculates a time required for recording the picture data based on the record information.

Preferably, the record information recording unit stores the record information for programmed recording. The first calculating unit calculates a capacity available for recording the picture data in the first recording unit during execution of recording based on the record information. The second calculating unit calculates a capacity required for recording the picture data based on the record information during execution of recording based on the record information.

Preferably, the record information recording unit stores the record information for programmed recording. The first calculating unit calculates a capacity available for recording the picture data in the first recording unit before execution of the recording based on the record information. The second calculating unit calculates a capacity available for recording the picture data based on the record information before execution of the recording based on the record information.

Preferably, the first calculating unit calculates an amount of recordable data as the capacity. The second calculating unit calculates an amount of the data to be recorded based on the record information.

Preferably, the data record/reproduction device further includes an order data recording unit storing data representing priorities of the writing of data to the first and second recording units; and a control unit controlling the first and second writing units to record the data according to the priorities.

Preferably, the data record/reproduction device further includes an input unit receiving the data representing the priorities; and a renewing unit storing the data representing the priorities received via the input unit in the order data recording unit.

Preferably, one of the first and second recording units includes a removable data record medium.

Preferably, one of the first and second recording units includes a magneto-optical record medium.

Preferably, one of the first and second recording units includes a record medium electrically storing the data.

Preferably, a data recording function of the first recording unit is the same as a data recording function of the second recording unit.

Preferably, a data recording function of the first recording unit is different from a data recording function of the second recording unit.

Preferably, the data record/reproduction device further includes a third recording unit storing the data; a third writing unit writing the data to the third recording unit; a third reproducing unit reading the data from the third recording unit; an order storing unit storing order of writing the data to the first, second and third recording units; and a control unit controlling the first, second and third writing units to record the data in the order.

Preferably, the order of writing the data is predetermined.

Preferably, the data record/reproduction device further includes a detecting unit detecting the recording unit inoperable to execute the recording in the order. When the detecting unit detects the recording unit inoperable to execute the recording in the order, the control unit controls the writing unit provided for writing the data to the recording unit having a next priority following the priority of the detected recording unit to write the data in the recording unit having the next priority.

According to another aspect of the invention, a data record/reproduction device includes a first recording unit storing picture data and information representing a record location of subsequent data to be recorded subsequently to the picture data; a second recording unit storing information for identifying the picture data stored in the first recording unit and the subsequent data; a first writing unit writing the data to the first recording unit; a first reproducing unit reading the data from the first recording unit; a second writing unit writing the data to the second recording unit; a second reproducing unit reading the data from the second recording unit; a record information recording unit storing the record information for programmed recording; a first calculating unit calculating a time available for recording the picture data by the first recording unit during execution of the recording based on the record information; a second calculating unit calculating a time required for recording the picture data based on the record information during execution of the recording based on the record information; a comparing unit comparing the time available for the recording and the required time; a first producing unit producing first record information representing subsequent storage of the picture data in the second recording unit when the required time exceeds the time available for the recording; a first control unit controlling the first writing unit to write the first record information in a predetermined region of the first recording unit; and a producing unit producing second record information representing the location of the subsequent data in the second recording unit when the required time exceeds the time available for the recording. The subsequent data is data recorded subsequently to the picture data stored in the first recording unit. The data record/reproduction device further includes a second control unit controlling the second writing unit to write the second record information in a predetermined region of the second recording unit; a write control unit controlling the second writing unit to record the picture data in the second recording unit subsequently to the recording of the picture data in the first recording unit by the first writing unit when the required time exceeds the time available for the recording; and a reproduction control unit controlling the second reproducing unit to reproduce the picture data subsequently to the reproduction by the first reproducing unit based on the second record information when the first record information is detected during reproduction of the picture data by the first reproducing unit.

The foregoing and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a block diagram illustrating a hardware structure of a DVD recorder according to a first embodiment of the invention.

FIG. 2 is a block diagram illustrating a data structure on a DVD loaded into the DVD recorder according to the first embodiment of the invention.

FIGS. 3 and 4 are flow charts illustrating procedures of processing executed by the DVD recorder according to the first embodiment of the invention.

FIG. 5 is a block diagram showing a hardware structure of a hard disk recorder according to a second embodiment of the invention.

FIG. 6 is a block diagram illustrating a form of recording of a control signal on a video cassette tape loaded into the hard disk recorder according to the second embodiment of the invention.

FIGS. 7 and 8 illustrate procedures of processing executed by the hard disk recorder according to the second embodiment of the invention.

FIG. 9 is a block diagram illustrating a data structure in a data record/reproduction device according to a first modification of the embodiment of the invention.

FIG. 10 is a block diagram illustrating a hardware structure of a data record/reproduction device according to a second modification of the embodiment of the invention.

FIG. 11 illustrates a manner of data storage in a memory 112 of a data record/reproduction device according to a third embodiment of the invention.

FIG. 12 is a flowchart illustrating a procedure of processing executed by a system control circuit 110.

FIG. 13 shows a screen image for setting recording priorities.

FIG. 14 is a flowchart illustrating a procedure of the processing executed by a system control circuit 110 for executing the recording based on the recording priorities.

FIG. 15 shows a hardware structure of a data record/reproduction device 1500 according to a fourth embodiment of the invention.

FIG. 16 illustrates a manner of data storage in memory 112 of data record/reproduction device 1500 according to the fourth embodiment of the invention.

FIG. 17 shows a hardware structure of a DVD recorder 1700 according to a fifth embodiment of the invention.

FIG. 18 shows a data structure of a DVD recorder 1700 according to the fifth embodiment of the invention.

FIG. 19 illustrates a data structure of a data record/reproduction device according to a modification of the fifth embodiment of the invention.

FIG. 20 conceptually illustrates a structure of a hard disk 144 of the data record/reproduction device according to the fifth embodiment of the invention.

FIG. 21 illustrates a structure of a system control circuit 110 achieving a data record/reproduction device according to another aspect of the invention.

### DESCRIPTION OF THE PREFERRED EMBODIMENTS

Embodiments of the invention will now be described with reference to the drawings. In the following description, the same parts bear the same reference numbers and the same names, and achieve the same functions. Therefore, description thereof is not repeated.

<First Embodiment>

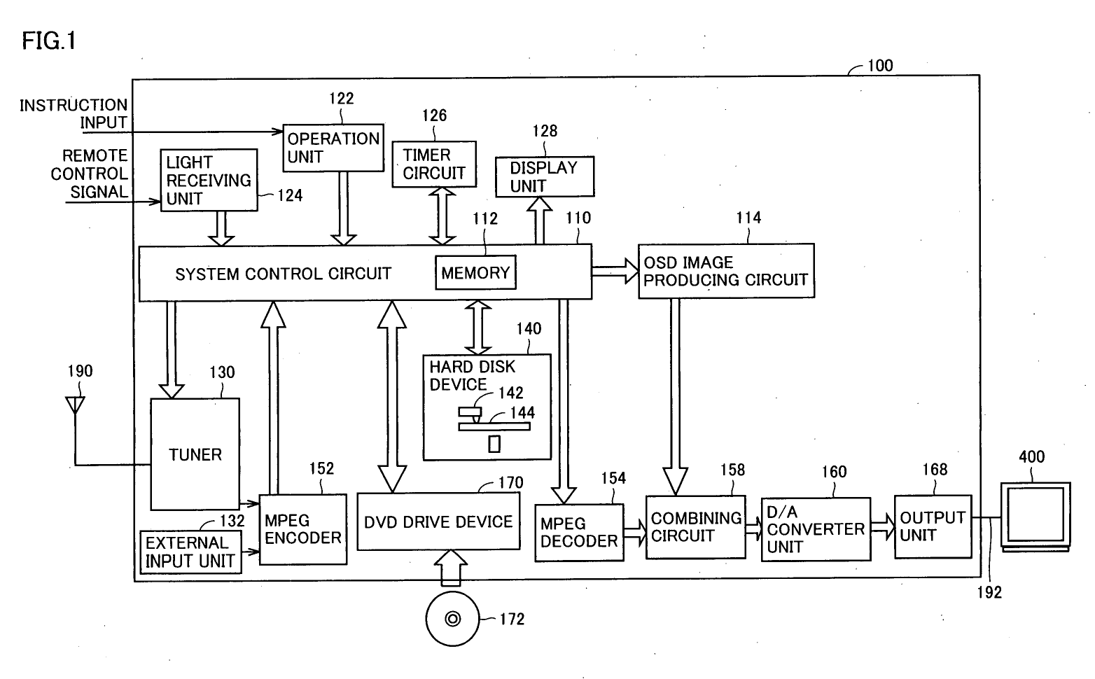

Referring to FIG. 1, description will now be given on a DVD recorder 100, which is one form of a data record/reproduction device according to an embodiment of the invention. FIG. 1 is a block diagram showing a hardware structure of DVD recorder 100.

DVD recorder 100 includes a memory 112 for storing data, a system control circuit 110 performing predetermined processing according to the stored data and an externally provided instruction, an operation unit 122 receiving an externally applied user's instruction, a light receiving unit 124 receiving a remote control signal and providing a predetermined control signal to system control circuit 110, a timer circuit 126 keeping a time for providing a signal to system control circuit 110, and a display unit 128 displaying information representing an operation state of DVD recorder 100. The operation state relates to time information of DVD recorder 100, a reception state of a tuner, which will be described later, a programmed recording state and others.

Referring to FIG. 1 again, DVD recorder 100 further includes an antenna 190, a tuner 130 tuning in to radio waves, which are instructed by system control circuit 110, among received radio waves, an external input unit 132 receiving externally provided picture and audio signals, a MPEG (Moving Picture Experts Group) encoder 152 compressing the received signals by predetermined processing, a hard disk device 140 storing digital data according to the instruction provided from system control circuit 110, a DVD drive device 170 driving a DVD 172 to record or reproduce the picture and audio data, a MPEG decoder 154 decoding the compressed picture and audio signals, an OSD (On Screen Display) image producing circuit 114 producing signals for displaying the operation state of DVD recorder 100 and other information on a screen displaying the picture, a combining circuit 158 combining the signal produced by OSD image producing circuit 114 with the output signal of MPEG decoder 154 to provide combined signals, a D/A (Digital to Analog) converter unit 160 providing an analog signal by converting a digital input signal to the analog signal, and an output unit 168, which can be connected to a transmission cable 192 for providing the picture and audio signals. The hard disk device 140 includes a hard disk 144, and a data record/reproduction head 142 recording and reproducing the data on or from hard disk 144. DVD recorder 100 is connected to a television set 400 via transmission cable 192.

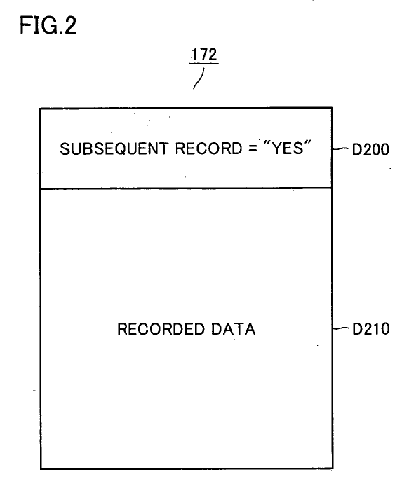

Referring to FIG. 2, description will now be given on a data structure on DVD 172 loaded into DVD recorder 100 according to the embodiment. FIG. 2 conceptually shows a structure of a data record region on DVD 172.

DVD 172 includes a system management region D200 for storing system information related to the stored picture data or audio data, and a region D210 for storing the picture data or audio data.

Region D200 stores data representing presence or absence of subsequent record in connection with the data recorded on DVD 172. This data includes, e.g., an ID (Identification) number for identifying another record medium and specific information relating to the execution of the subsequent recording. The specific information relates to, e.g., date and time of execution of the subsequent recording, and a serial number successively produced in a predetermined sequence every time the subsequent recording is executed.

Region D210 can store, e.g., the picture data, which is selected by tuner 130 and is recorded in a record mode designated by the user. The number of files formed of the picture data, which is stored in region D210, is not particularly restricted.

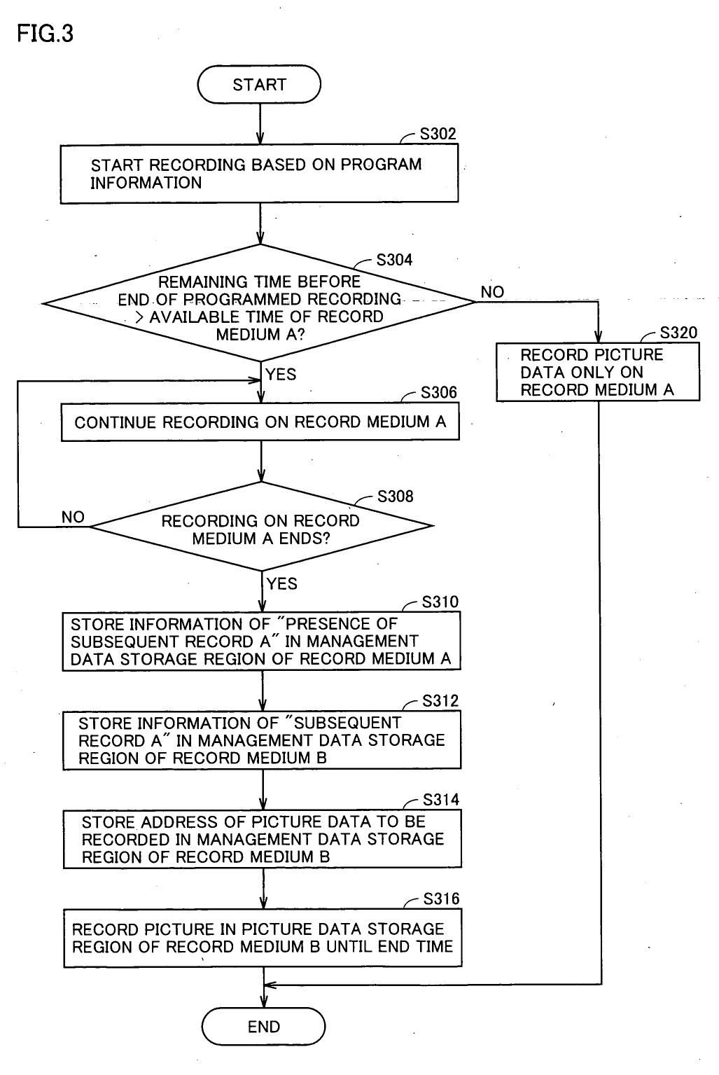

Referring to FIG. 3, description will now be given on a control structure of DVD recorder 100 according to the embodiment. FIG. 3 is a flowchart representing a procedure of the processing executed for recording by system control circuit 110.

In a step S302, system control circuit 110 starts the recording based on the programmed record information stored in memory 112. In a step S304, system control circuit 110 determines whether a remaining time before the end of the programmed recording exceeds a time available for recording on a record medium A (e.g., DVD 172) or not, according to the time data provided from timer circuit 126 and the recorded data stored in memory 112. If the remaining time before the end of programmed recording exceeds the available time of record medium A (YES in step S304), the processing proceeds to a step S306. If not (NO in step S304), the processing proceeds to a step S320.

In a step S306, system control circuit 110 continues the recording on record medium A. In a step S308, system control circuit 110 determines whether the recording on record medium A ends or not, according to the storage state of the information on record medium A stored in memory 112 or the time information provided from timer circuit 126. If it is determined that the recording ends (YES in step S308), the processing proceeds to a step S310. If not (NO in step S308), the processing returns to step S306.

In step S310, system control circuit 110 stores the information, which represents the “presence of subsequent record A”, in the management data storage region on record medium A. For example, a predetermined code is stored in this region. In a step S312, system control circuit 110 stores the information of the subsequent record A in the management data storage region on a record medium B (e.g., hard disk device 140).

In step S314, system control circuit 110 stores an address of the picture data to be recorded in the management data storage region on record medium B. In a step S316, system control circuit 110 records the picture in the picture data storage region on record medium B until the end time of the programmed recording.

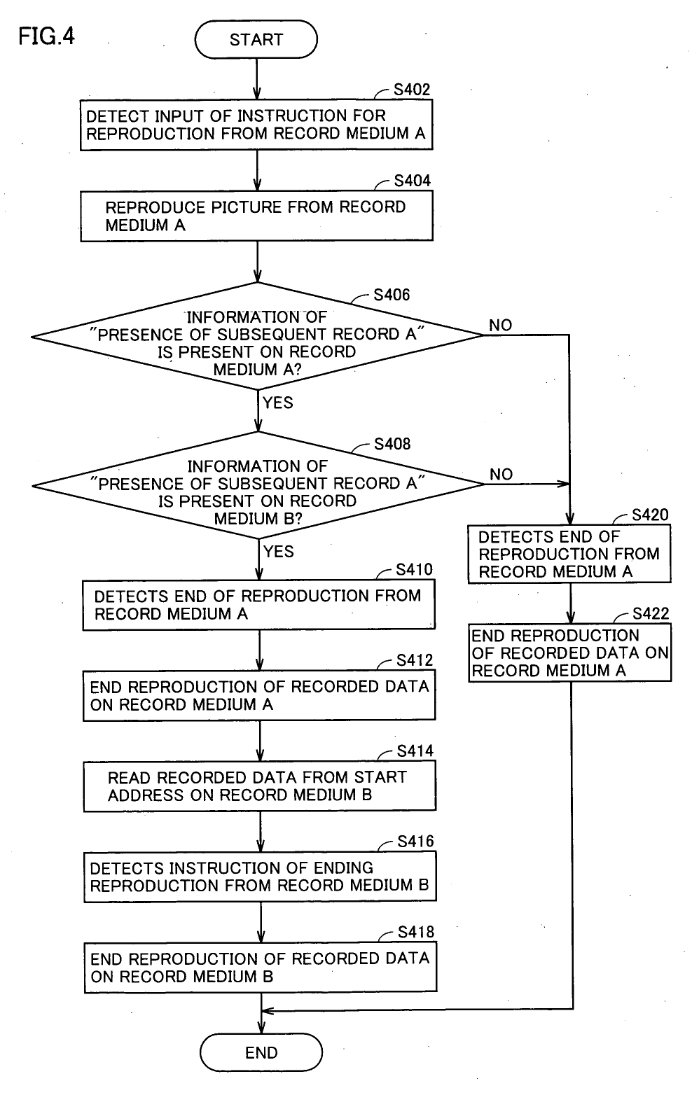

Referring to FIG. 4, further description will now be given on the control structure of DVD recorder 100 according to the embodiment. FIG. 4 is a flowchart representing a procedure of the processing executed by system control circuit 110 when the picture is reproduced.

In a step S402, system control circuit 110 detects input of an instruction for reproducing the data on record medium A, according to a signal provided from operation unit 122 or light receiving unit 124. In a step S404, system control circuit 110 reads and reproduces the picture from record medium A. In a step S406, system control circuit 110 determines whether the information representing the presence of subsequent record A continued from record medium A is present or not, according to the data stored in the management data storage region. If such information is present, (YES in step S406), the processing proceeds to a step S408. If not (NO in step S406), the processing proceeds to a step S420.

In step S408, system control circuit 110 determines whether information of subsequent record A is present in the management data storage region on record medium B or not. If such information is present (YES in step S408), the processing proceeds to a step S410. If not (NO in step S408), the processing proceeds to step S420.

In step S410, system control circuit 110 detects the end of reproduction from record medium A. In a step S412, system control circuit 110 completes the reproduction of the recorded data on record medium A.

In a step S414, system control circuit 110 reads the recorded data from a start address on record medium B. In a step S416, system control circuit 110 detects an instruction to end the reproduction from record medium B. In a step S418, system control circuit 110 ends the reproduction of the recorded data on record medium B according to the detected instruction.

In step S420, system control circuit 110 detects the end of reproduction from record medium A. In a step S422, system control circuit 110 ends the reproduction of the recorded data on record medium A.

According to the structures and flowcharts already described, DVD recorder 100 of the embodiment operates as follows.

[Recording]

When the time of timer circuit 126 in DVD recorder 100 attains the programmed time, the recording starts based on the programmed information (step S302). If the time to the end time of the programmed recording is loner than the time available for recording on DVD 172 (YES in step S304), the picture data is first recorded on DVD 172 (step S306). If the region on DVD 177 fully bears the data, and can no longer record the data (YES in step S308), the information of “presence of subsequent record (DVD 172)” is stored in the management data storage region on DVD 172 (step S310). Thereafter, DVD recorder 100 stores the information of the subsequent record (DVD 172) in a predetermined management data storage region on hard disk 144, and records the picture in the picture data storage region on hard disk 144 until the end time of programmed recording (step S316). [Reproduction]

When a user performs a predetermined reproduction operation on DVD recorder 100 to provide an instruction for reproduction from DVD 172 (step S402), DVD recorder 100 reads the picture data from DVD 172 in DVD drive device 170, and provides the picture to television set 400 (step S404). If the management data storage region on DVD 172 bears the information representing the presence of the subsequent record (YES in a step S406), it is further determined whether the management data storage region on hard disk 144 bears similar information or not. If hard disk 144 bears the information of subsequent record (DVD 172) (YES in a step S408), the subsequent picture data on hard disk 144 is reproduced (step S414) after the end of reproduction of the picture from DVD 172 (step S412).

In the above manner, DVD recorder 100 according to the embodiment records the picture on hard disk 144 subsequently to the recording on DVD 172. In this operation, DVD recorder 100 stores the information, which represents the presence of the subsequent record on hard disk 144, on DVD 172. This information includes, e.g., the date and time of recording as well as information for identifying hard disk 144, or a code predetermined in DVD recorder 100. Thereafter, DVD recorder 100 records the picture on hard disk 144. Also, DVD recorder 100 produces and stores the information, which represents that the recording is continued from the recording on DVD 172. This information includes, e.g., identification number of DVD 172.

In the above manner, since the reproduction of data on hard disk 144 can be executed continuously after the reproduction of data on DVD 172, the reproduction of picture is not interrupted. Therefore, the user can enjoy watching the picture without performing a particular operation for continuous reproduction.

<Second Embodiment>

A second embodiment of the invention will now be described. A hard disk recorder 500 according to the second embodiment of the invention differs from the first embodiment in that hard disk 144 and a video tape are used as data record mediums.

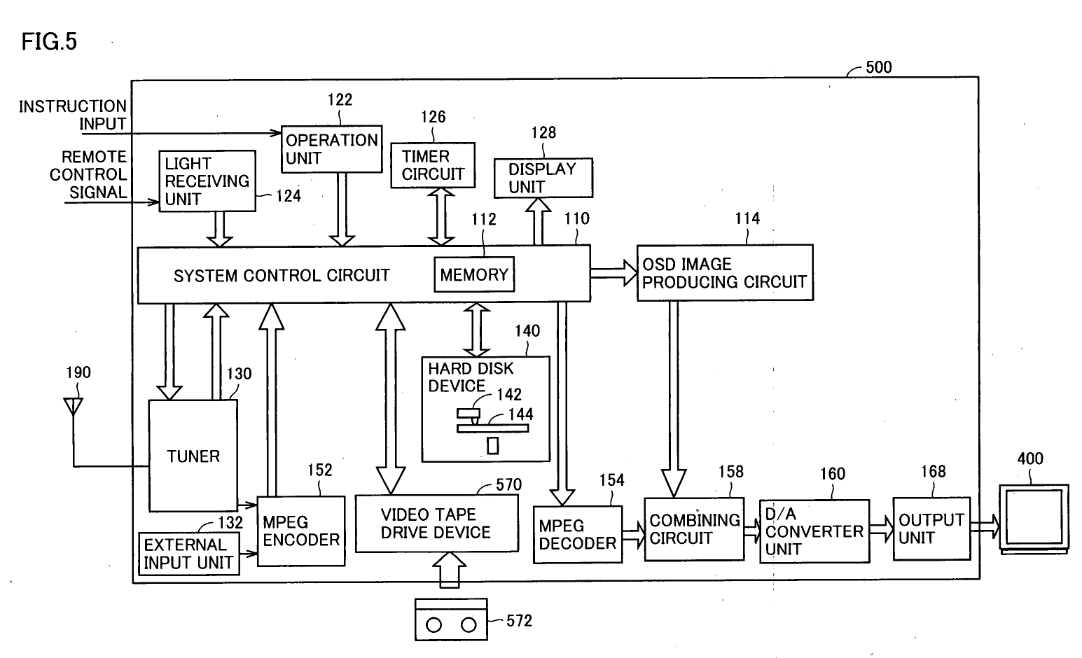

Referring to FIG. 5, description will now be given on hard disk recorder 500 according to the second embodiment. FIG. 5 is a block diagram showing a hardware structure of hard disk recorder 500. The same components as those in DVD recorder 100 according to the first embodiment bear the same reference numbers, and achieve the same functions. Therefore, description thereof is not repeated.

Hard disk recorder 500 includes a video tape drive device 570, which is loaded with a video cassette tape 572.

System control circuit 110 of hard disk recorder 500 writes picture and audio data of a broadcasting station selected by tuner 130 to video cassette tape 572. When the writing of the picture and audio data is not completed even when the data is written on the end of video cassette tape 572, system control circuit 110 stores subsequent picture and audio data on another record medium, i.e., hard disk 144. System control circuit 110 produces information representing this switching of the storage destination of the data. This information includes, e.g., date and time of recording of the picture and audio data as well as information (e.g., a serial number), which is already prepared for identifying hard disk 144.

System control circuit 110 further produces management information representing the fact that the record of the picture and audio data on hard disk 144 is continued from the record of the data stored on video cassette tape 572. System control circuit 110 stores the management information in the management data record region on hard disk 144. The management information may be stored in a portion other than hard disk 144, and may be stored, e.g., in memory 112.

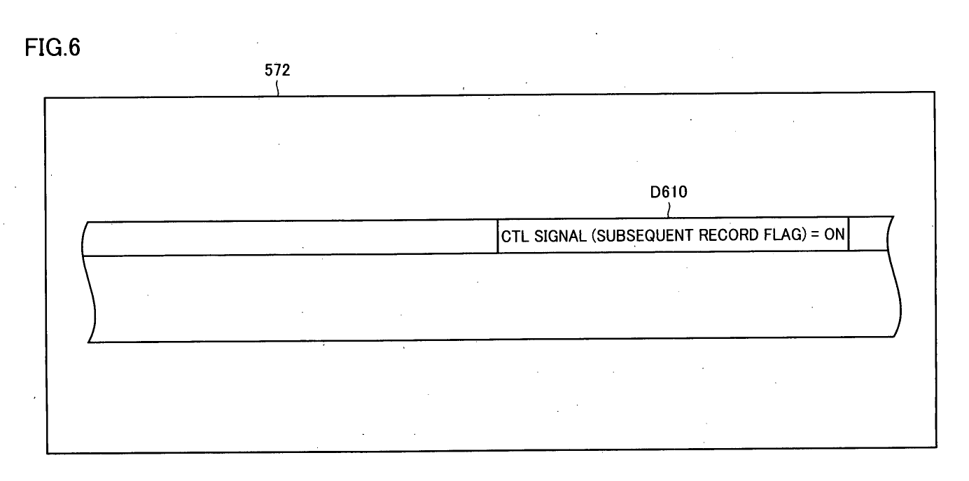

Referring to FIG. 6, description will now be given on a data structure on video cassette tape 572. FIG. 6 conceptually shows a form of signal storage on video cassette tape 572.

Video cassette tape 572 includes a region storing picture or audio signals as well as a region storing control signals. Region D610 stores, e.g., a CTL signal (subsequent record flag). This signal is recorded based on a predetermined input at the time of picture recording. For example, when a mode for continuous recording is active according to setting in the operation of recording the picture on video cassette tape 572, system control circuit 110 stores the CTL signal, which represents the fact that the continuous recording is valid based on such setting, in region D610.

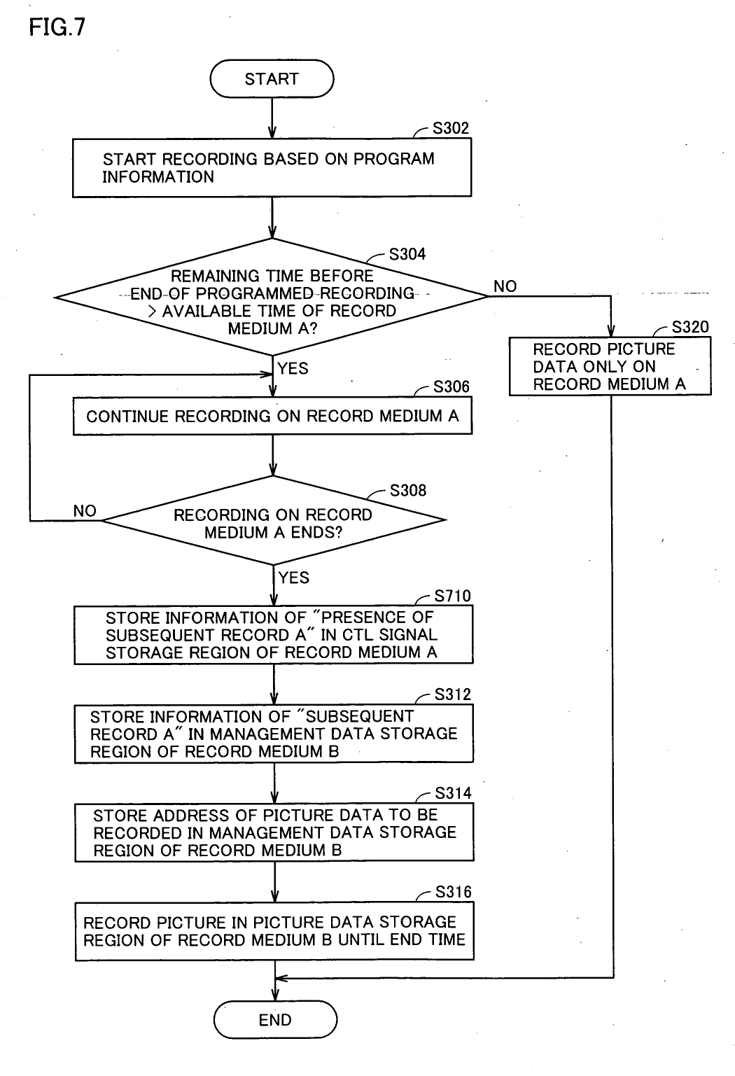

Referring to FIG. 7, description will now be given on a control structure of hard disk recorder 500 according to the embodiment. FIG. 7 is a flowchart illustrating a procedure of processing executed by system control circuit 110 of hard disk recorder 500. The steps performing the same processing as those in the first embodiment bear the same step numbers, and description thereof is not repeated.

In step S308, system control circuit 110 determines whether the recording on record medium A (video cassette tape 572) is completed or not. If the recording is completed (YES in step S308), the processing proceeds to a step S710. In step S710, system control circuit 110 stores the CTL signal representing the “presence of subsequent record A” in the CTL signal storage region on video cassette tape 572.

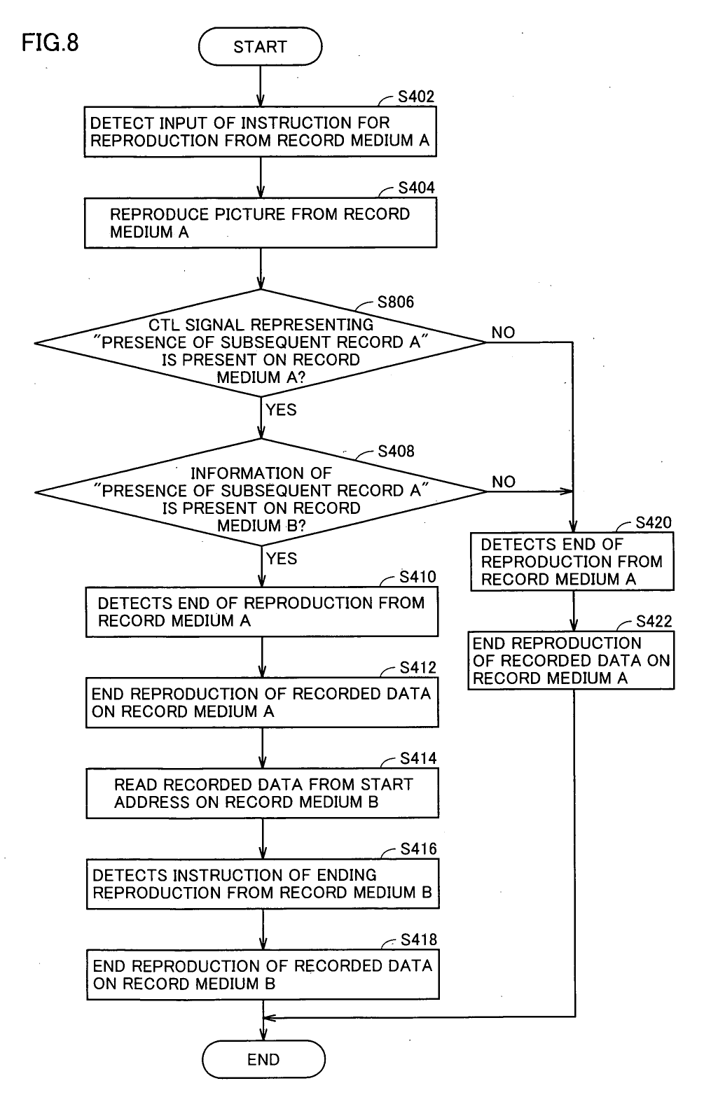

Referring to FIG. 8, the control structure of hard disk recorder 500 will now be described further. FIG. 8 is a flowchart illustrating a procedure of processing, which is executed by system control circuit 110 for picture reproduction. The steps performing the same processing as those in the first embodiment bear the same step numbers, and description thereof is not repeated.

In a step S806, system control circuit 110 determines whether the CTL signal representing the “presence of subsequent record A” is present on record medium A (video cassette tape 572) or not. If the signal is present (YES in step S806), the processing proceeds to step S408. If not (NO in step S806), the processing proceeds to step S420.

Based on the structure and flowcharts described above, hard disk recorder 500 according to the embodiment operates as follows. Description of the same operations as those already described is not repeated.

[Recording]

When timer circuit 126 of hard disk recorder 500 detects that the current time reaches the programmed or preselected time, the recording starts according to the program information (step S302). If the region on video cassette tape 572 fully bears the data, and can no longer record the data (YES in step S308), the information of “presence of subsequent record A” is stored on a CTL signal storage region of video cassette tape 572 (step S710).

[Reproduction]

When a user executes a predetermined operation on hard disk recorder 500 to enter an instruction for reproduction of video cassette tape 572, hard disk recorder 500 detects the instruction (step S402). Hard disk recorder 500 reads the picture data from video cassette tape 572 loaded into video tape drive device 570, and provides the picture data to television set 400 (step S404). If the information of “presence of subsequent record A” is stored in a predetermined region on video cassette tape 572 (YES in step S806), and if hard disk 144 has stored the picture data corresponding to the above information (YES in step S408), reproduction from hard disk 144 is executed after reproduction from video cassette tape 572 (steps S410-S414).

According to hard disk recorder 500 of this embodiment, as described above, the picture is recorded on hard disk 144 subsequently to the recording on video cassette tape 572. In this operation, hard disk recorder 500 stores the information, which represents the presence of the subsequent record on hard disk 144, on video cassette tape 572. This information includes the date and time of record, information for identifying hard disk 144, a code predetermined in hard disk recorder 500, a number assigned in response to every execution of the continuous recording or the like. Thereafter, hard disk recorder 500 records the picture on hard disk 144. Also, hard disk recorder 500 produces the information, which represents that the record on hard disk 144 continues from that on video cassette tape 572, and stores it.

In this manner, since the reproduction from hard disk 144 can be executed continuously after the reproduction of the picture on video cassette tape 572, the picture reproduction is not interrupted. Therefore, the user can enjoy watching the picture without performing a particular operation for continuous reproduction.

A modification of the embodiment of the invention will now be described.

<First Modification>

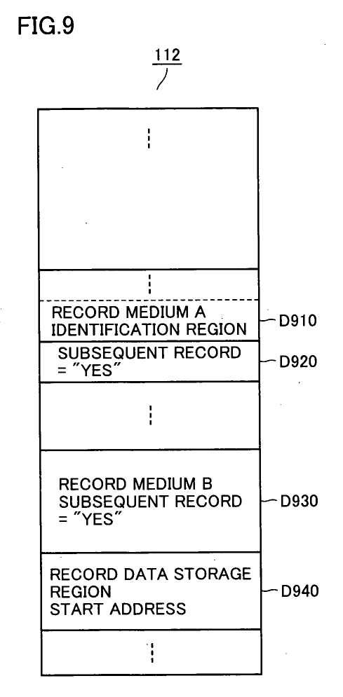

Referring to FIG. 9, description will now be given on a modification of DVD recorder 100 or hard disk recorder 500 according to the first or second embodiment. In the foregoing embodiments, the data stored on the record medium for representing the presence/absence of the subsequent record is stored in the predetermined management data storage region on each record medium. The data may be stored in a portion other than the removable mediums, and may be stored, e.g., in a memory provided in DVD recorder 100 or hard disk recorder 500.

Memory 112 has a region storing management information for each record medium. A region D910 stores identification information of record medium A (DVD 172, video cassette tape 572 or another removable record medium). A region D920 stores the data representing presence/absence of the subsequent record. A region D930 stores the data representing the presence/absence of the subsequent record on record medium B (hard disk 144). A data region D940 stores the data representing the leading address of the region bearing the recorded data.

Based on the management information stored in DVD recorder 100 or hard disk recorder 500, the presence/absence of the subsequent record can be rapidly determined so that the picture can be reproduced seamlessly.

<Second Modification>

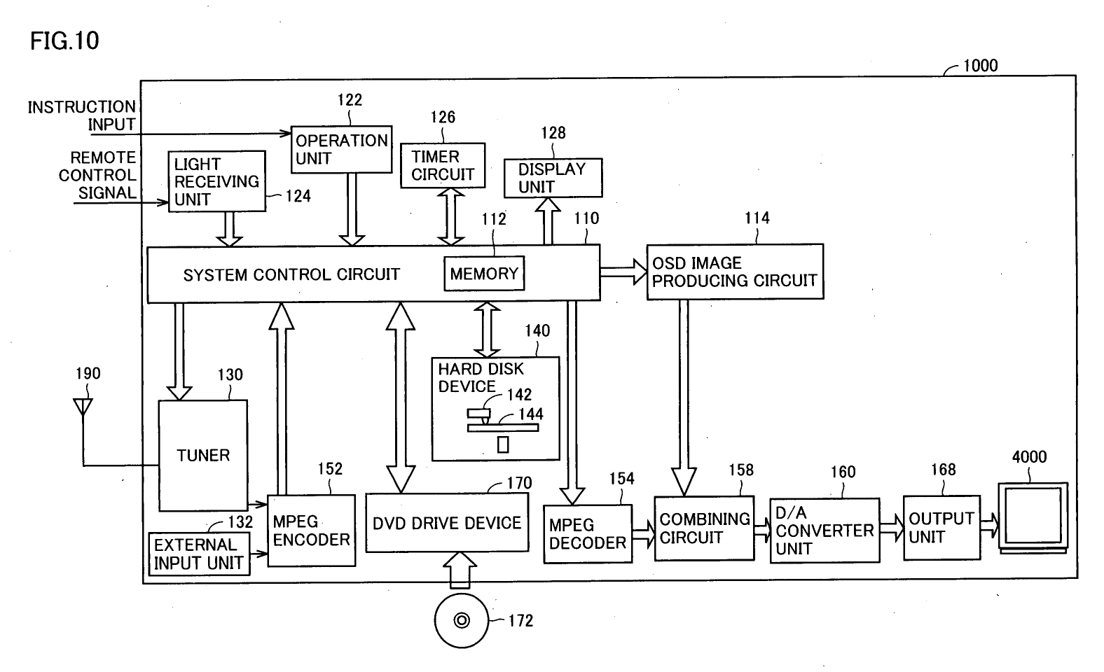

Referring to FIG. 10, another modification of the embodiment will now be described. In the embodiments already described, the display unit (e.g., television set 400) for displaying the picture is connected to DVD recorder 100 or hard disk recorder 500 via a cable (not shown). However, the record/reproduction device may be provided with a monitor. For example, as shown in FIG. 10, a DVD recorder 1000 having functions of recording and reproducing picture data may be provided with a monitor unit 4000 for displaying the picture.

In the embodiments and the modifications already described, a comparison between the remaining time before the end of programmed recording and the time available for recording on record medium A is performed after starting the recording. This comparison may be performed before starting the recording. In this case, when the user enters, e.g., information for programmed recording, the user may be informed of to that effect so that the user can select a recording format, or can load another record medium (i.e., a blank video cassette tape or DVD), if necessary. Thus, the user can gain an opportunity of selecting the medium for recording the picture or audio data.

<Third Embodiment>

A third embodiment of the invention will now be described. The data record/reproduction device according to the embodiment differs from the data record/reproduction devices of the embodiments already described in that the device has a function of continuously executing the recording on a plurality of record mediums based on data determining the order of the recording. The data record/reproduction device according to this embodiment has the same hard ware structures as DVD recorder 100 (FIG. 1) or hard disk recorder 500 (FIG. 5), and have the same functions as those of the recorders. Therefore, the description of such structures and functions is not repeated.

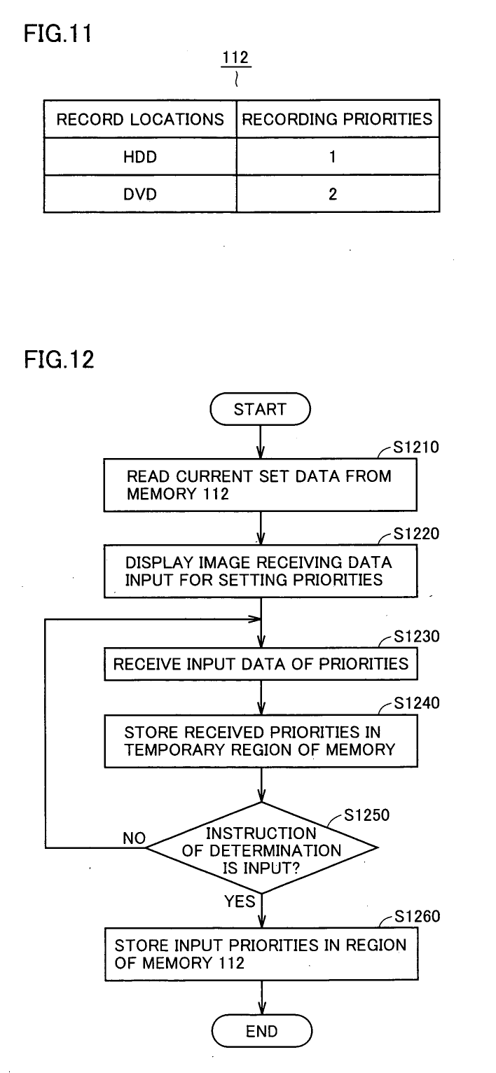

Referring to FIG. 11, the data structure of the data record/reproduction device according to this embodiment will now be described. FIG. 11 represents a manner of data storage in memory 112. Memory 112 stores the data representing a record address or location of the data as well as data (priorities) determining the order of execution of recording. These data are mutually related.

For example, when the data record/reproduction device includes the HDD and DVD as record mediums, a recording priority of “1” is assigned to the HDD, and a recording priority of “2” is assigned to the DVD. In this case, the record processing according to the record instruction is first effected on the HDD, and then is effected on the DVD.

The user can set the above recording priorities, and also can set some other priorities, as will be described later. For example, similar priorities can be set for the reproduction. In this case, memory 112 has a structure, which is similar to the data structure shown in FIG. 11, for the data for reproduction.

Referring to FIG. 12, description will now be given on a control structure of a data record/reproduction device according to the embodiment. FIG. 12 is a flowchart illustrating a procedure of the processing executed by system control circuit 110.

In a step S1210, system control circuit 110 reads current set data from memory 112. In a step S1220, system control circuit 110 displays a screen image, which allows input of data for setting recording priorities. This display is achieved by reading the data for displaying the above screen image by system control circuit 110.

In a step S1230, system control circuit 110 receives the data relating to the recording priorities, which are determined by the operation of operation unit 122 or by the signal emitted from a remote control terminal (not shown). In a step S1240, system control circuit 110 stores the received recording priorities in a region of memory 112. This region is used for temporarily storing the data while executing temporary processing.

In a step S1250, system control circuit 110 determines whether the instruction defining the recording priorities is entered or not. If system control circuit 110 determines that the instruction is received (YES in step S1250), the processing proceeds to a step S1260. If not (NO in step S1250), the processing returns to step S1230. In step S1260, system control circuit 110 stores the received recording priorities in a region of memory 112 (FIG. 11).

In this manner, the user of the data record/reproduction device can change the recording priorities stored in memory 112. Therefore, the user can change the order of use of the record mediums when the continuous recording is to be performed according to the form of use of the data record/reproduction device.

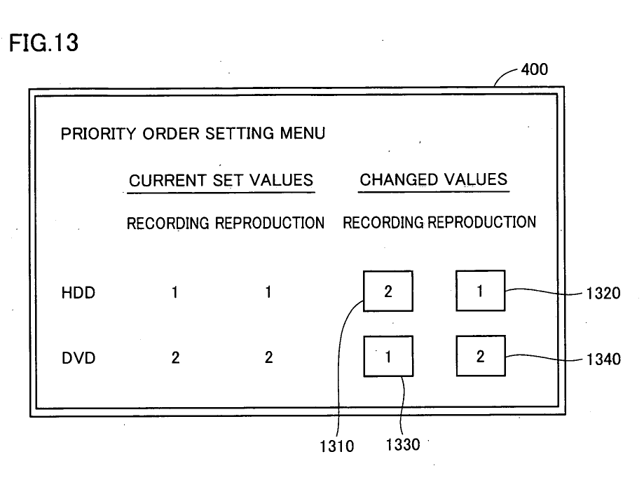

Referring to FIG. 13, description will now be given on a form of display on television set 400 connected to the data record/reproduction device according to the embodiment. FIG. 13 shows a screen image for setting the recording priorities or order. When the processing in step S1220 is executed, television set 400 displays this screen image.

More specifically, television set 400 displays the screen image shown in FIG. 13 when the user operates operation unit 122 or the remote control terminal to enter the instruction for changing the setting of priorities. This screen image has portions displaying the recording priorities, which are currently set for the respective record mediums in the data record/reproduction device, and also has portions, in which the user enters data of priorities for changing the displayed recording priorities.

For example, data representing the priorities can be entered in regions 1310-1340. When the user assigns the priorities of “2” and “1” to the HDD and the DVD, respectively, the current set values are changed. In this case, the recording priorities can be set independently of the setting of the reproduction priorities.

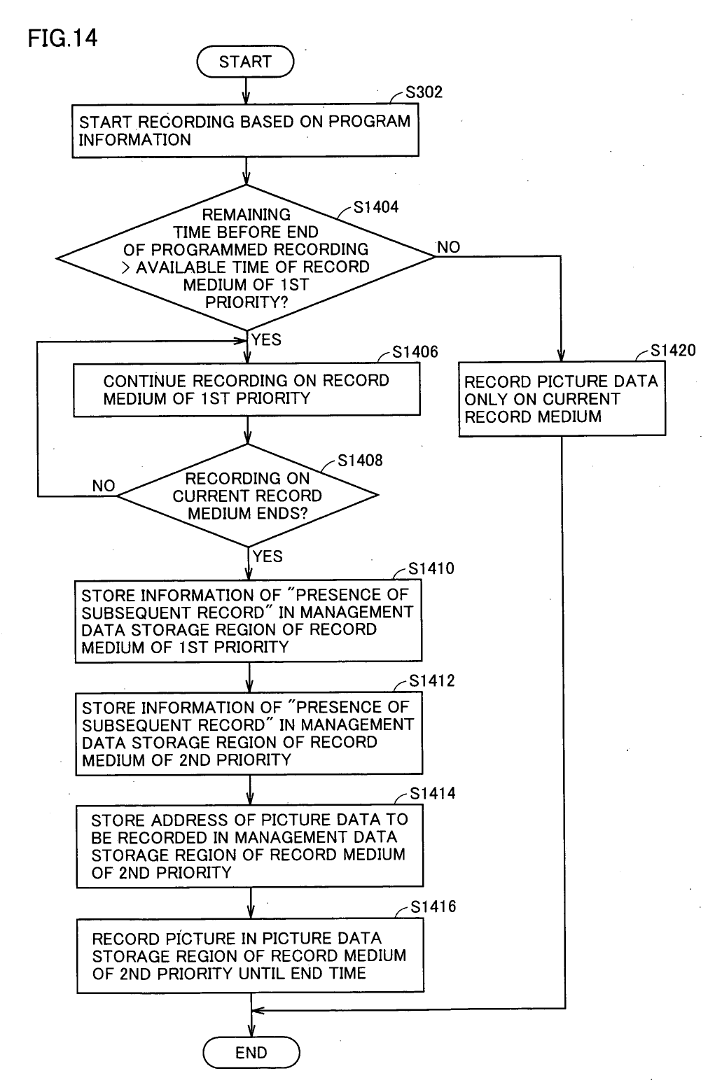

Referring to FIG. 14, further description will now be given on the control structure of the data record/reproduction device according to the embodiment. FIG. 14 is a flowchart illustrating a procedure of processing, which is executed by system control circuit 110 for executing the recording based on the recording priorities. The steps performing the same processing as those already described bear the same step numbers, and description thereof is not repeated.

In a step S1404, system control circuit 110 determines whether the remaining time before the end of programmed recording is longer than the available time of the record medium of the first priority or not. If system control circuit 110 determines that the remaining time before the end of programmed recording is longer than the available time of the record medium of the first priority (YES in step S1404), the processing proceeds to a step S1406. If not (NO in step S1404), the processing proceeds to a step S1420.

In step S1406, system control circuit 110 continues the recording on the record medium of the first priority. In a step S1408, system control circuit 110 determines whether the recording on the record medium of the first priority ends or not. This determination is executed according to the detection/non-detection of the control data representing the end of the region available for data recording. If system control circuit 110 determines that the recording on the record medium is already completed (YES in step S1408), the processing proceeds to a step S1410. If not (NO in step S1408), the processing returns to step S1406.

In step S1410, system control circuit 110 stores the information representing “presence of subsequent record” in the management data storage region of the record medium of the first priority. In a step S1412, system control circuit 110 stores the information related to the continued recording in the management data storage region of the record medium of the second priority. In a step S1414, system control circuit 110 stores an address of the picture data to be recorded in the management data storage region of the record medium of the second priority. In a step S1416, system control circuit 110 records the picture in the picture data storage region of the record medium of the second priority until the end time. In step S1420, system control circuit 110 records the picture data only in the record medium of the first priority.

In the foregoing manners, the user of the data record/reproduction device according to the embodiment can set the priorities of the recording according to user's preferences or purpose of use. According to the data record/reproduction device of another aspect, the user can set the priorities of the reproduction in addition to the priorities of the recording. This can improve the convenience of the data record/reproduction device in connection with the recording and/or reproducing of the picture.

<Fourth Embodiment>

A fourth embodiment of the invention will now be described. A data record/reproduction device according to the fourth embodiment of the invention differs from the data record/reproduction devices of the embodiments already described in that three kinds of record mediums are employed, and can be continuously used for recording and/or reproducing.

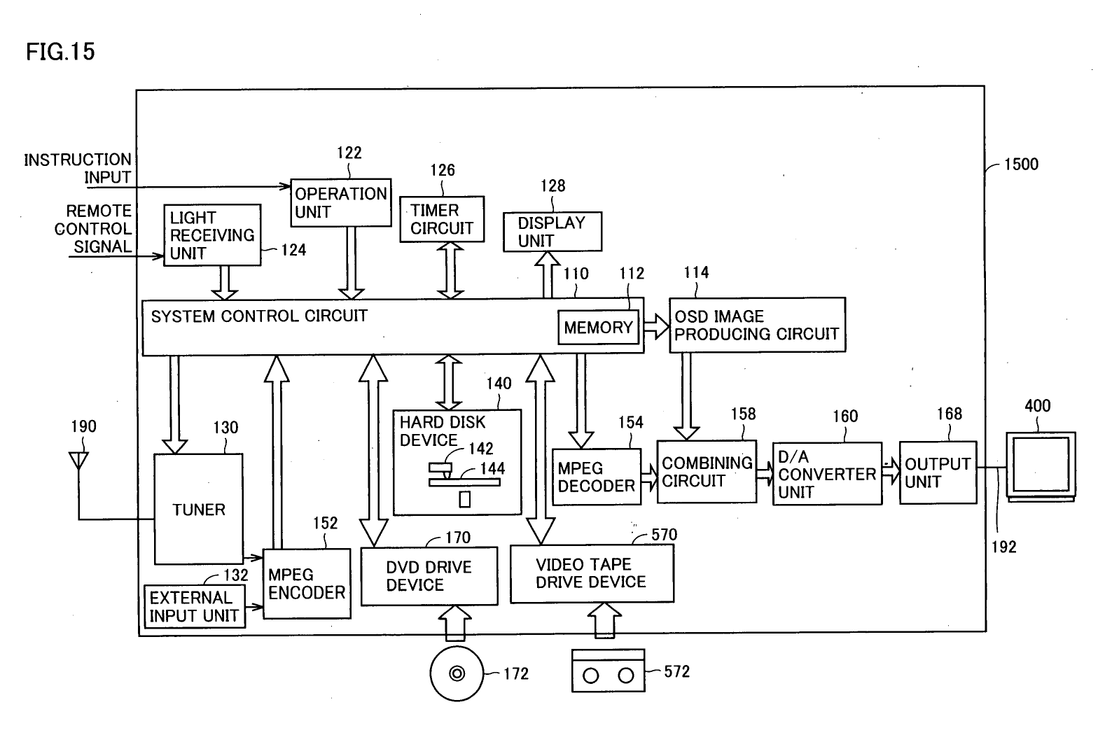

Referring to FIG. 15, description will now be given on a hardware structure of a data record/reproduction device 1500 according to this embodiment. Data record/reproduction device 1500 includes video tape drive device 570 in addition to the structure shown in FIG. 1. Video tape 572 is loaded into video tape drive device 570.

Video tape drive device 570 operates according to the signal provided from system control circuit 110 to record the picture and/or audio signals on video tape 572, or to read recorded signals for reproduction. Video tape drive device 570 may operate according to the instruction applied from operation unit 122 or light receiving unit 124, or may operate according to preset priorities, as will be described later.

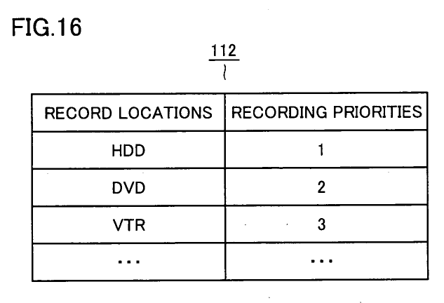

Referring to FIG. 16, a data structure of data record/reproduction device 1500 according to this embodiment will now be described. FIG. 16 illustrates a manner of data storage in memory 112.

Memory 112 stores data for identifying the respective record mediums as well as respective priorities of recording assigned to them. These data are related to each other. More specifically, the recording priority of “1” is assigned to the HDD, and the recording priority of “2” is assigned to the DVD. The recording priority of “3” is assigned to the Video Cassette Tape. By assigning the priorities to the respective record mediums, the order of recording or the order of reproduction is controlled so that the operation according to the manner or form of use of data record/reproduction device 1500 can be achieved.

Data record/reproduction device 1500 may employ a record medium of a type other than those shown in FIG. 15. For example, it may employ a flash memory or other semiconductor memory devices. The semiconductor memory devices can suppress power consumption of a drive unit.

System control circuit 110 can continuously record a long-time program according to the recording priorities stored in memory 112. For preventing remaining of a blank portion, system control circuit 110 may be configured such that the picture data of a predetermined length (e.g., one minute) to be recorded on the end portion of the preceding record medium and the picture data of a predetermined length to be recorded on the start portion of the subsequent record medium are recorded on each of these two record mediums. In this manner, the user can reproduce the picture by data record/reproduction device 1500 without interruption.

<Fifth Embodiment>

A fifth embodiment of the invention will now be described. In the foregoing embodiments already described, each of the data record/reproduction devices employs the plurality of record mediums, which store the data in different recording formats, respectively. However, the data record/reproduction device according to the invention may employ the plurality of record mediums achieved by the same functions. For example, the plurality of removable record mediums such as DVDs or video tapes may be loaded into the device. Alternatively, a hard disk or the like, which is physically one medium, may be used, in which case the medium is configured to have a plurality of divided regions so that these regions can be controlled independently of each other for recording and reproducing the picture and audio data.

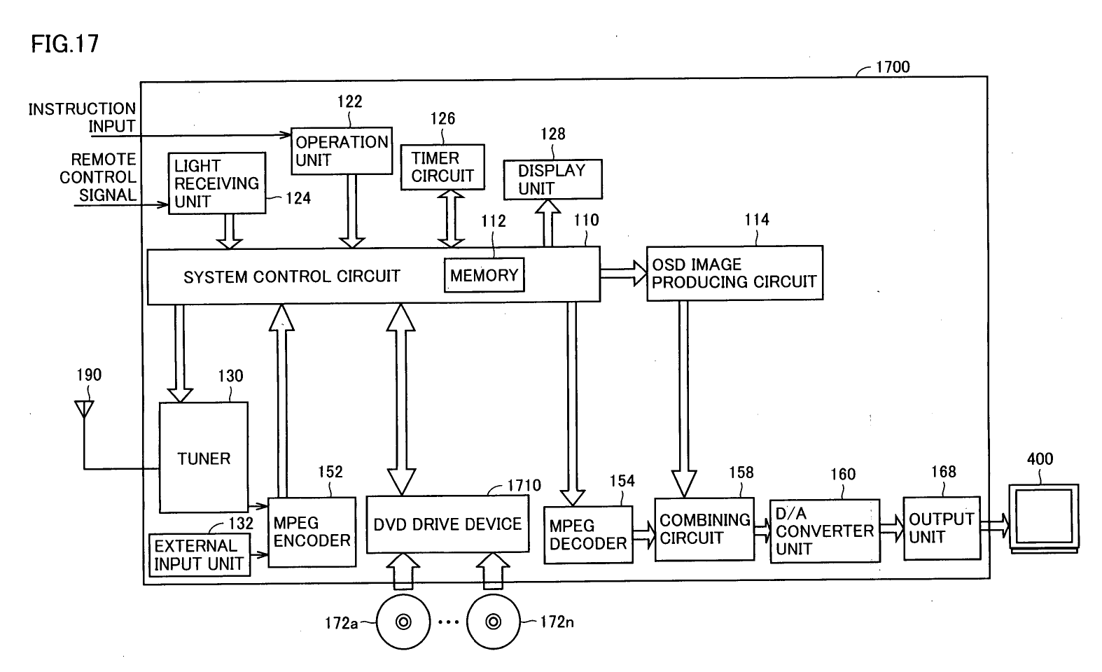

Referring to FIG. 17, a DVD recorder 1700 according to the embodiment includes a DVD drive device 1710, into which a plurality of DVDs 172a-172n can be loaded, in contrast to the structure shown in FIG. 1. DVD recorder 1700 does not have a hard disk device in contrast to the structure shown in FIG. 1. DVD drive device 1710 can execute the recording and reproducing of data on each of the disks according to the signal provided from system control circuit 110. The data recording and producing on or from each disk may be performed according to the instruction provided from operation unit 122 or light receiving unit 124, or may be executed according to the data prestored in memory 112.

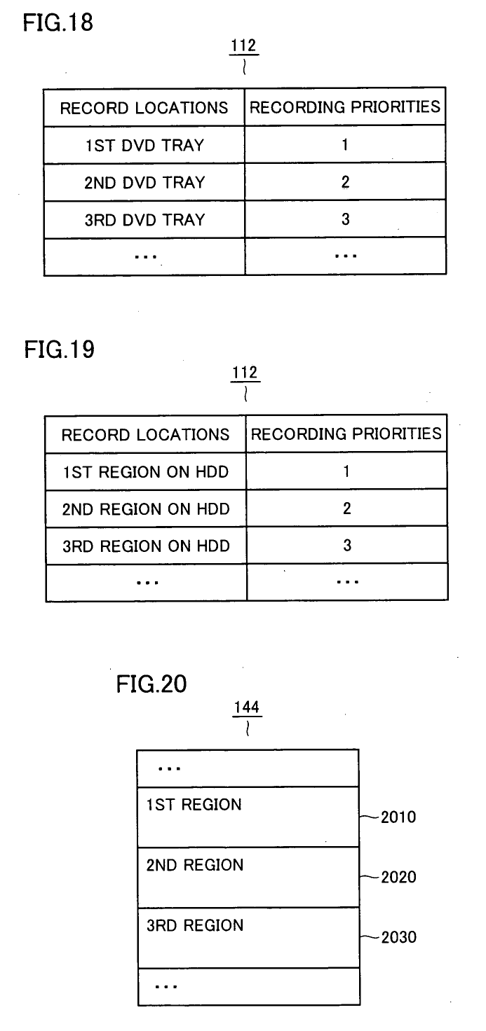

Referring to FIG. 18, a data structure of DVD recorder 1700 according to the embodiment will now be described. FIG. 18 illustrates a manner of data storage in memory 112. Memory 112 has stored data identifying a loading location of the DVD in DVD drive device 1710, i.e., a tray of the DVD. Further, memory 112 has stored the recording priorities assigned to the respective trays.

For example, the recording priority of “1” is assigned to the first DVD tray. Also, the recording priorities of “2” and “3” are assigned to the second and third DVD trays, respectively. By assigning the priorities to the trays in DVD drive device 1710 as described above, the recording is performed by successively effecting the recording on the respective disks according to the priorities.

The above priorities can be changed by an appropriate operation of the user. Such change can be achieved in a manner already described in connection with the third embodiment.

<Modification>

A modification of this embodiment will now be described. The data record/reproduction device according to this embodiment is data recorder 1700, into which the plurality of DVDs can be loaded. However, the record medium may be unremovable. For example, a record medium such as a HDD allowing random access may be used, and a plurality of divided regions, which are prepared in advance, may be used for recording or reproducing the data according to preset priorities.

Referring to FIG. 19, a data structure of the data record/reproduction device according to this modification will now be described. FIG. 19 illustrates a manner of data storage in memory 112 of the data record/reproduction device, which is provided with a HDD (and is, e.g., the same as DVD recorder 100 shown in FIG. 1 except for that DVD drive device 170 is not employed).

Memory 112 stores the data for identifying first, second and third regions of the HDD, which are divided in advance. Each data is related to the recording priority. A size (an amount of recordable data) of each region can be freely changed by user's setting when formatting the HDD. In the example illustrated in FIG. 19, the recording priority of “1” is assigned to the first region of the HDD. The HDD may contain the regions more or fewer than three (FIG. 19), and may contain more divided regions. Also, the divided regions may be combined according to the user's setting. The recording priorities assigned to the respective regions may be changeable according to the user's setting, as already described in connection with the third embodiment.

Referring to FIG. 20, a structure of hard disk 144 of the data record/reproduction device according to this embodiment will now be described. FIG. 20 conceptually illustrates the structure of hard disk 144. Hard disk 144 includes first, second and third regions 2010, 2020 and 2030. When the data record/reproduction device executes the recording according to the priorities illustrated in FIG. 19, data record/reproduction head 142 first executes the recording on first region 2010.

When first region 2010 fully stores the data, and can no longer record the data, system control circuit 110 changes the data record destination from first region 2010 to second region 2020. Thus, system control circuit 110 provides a signal, which represents the data record destination, to data record/reproduction head 142, and thereby instructs data record/reproduction head 142 to record the picture data in second region 2020. When second region 2020 fully stores the data, system control circuit 110 provides a similar signal to data record/reproduction head 142, and thereby controls data record/reproduction head 142 to change the recording destination from second region 2020 to third region 2030.

In an operation of reproducing the picture data, data record/reproduction head 142 reads the data in a similar manner according to the instruction for reproduction. Although hard disk 144 is physically one record medium, each region is handled virtually as an independent medium. Therefore, the user can edit or delete the data in only a specific region. This improves convenience of the data record/reproduction device.

As described above, the control of the data record/reproduction device according to this embodiment is achieved primarily by executing the preset processing by system control circuit 110 according to the data stored in memory 112. System control circuit 110 is achieved by employing circuits executing respective kinds of processing.

Instead of the above structure, the data record/reproduction device according to the invention can be achieved by executing program products achieving respective kinds of processing by a CPU (Central Processing Unit) or another processor. In this case, system control circuit 110 has the following structure.

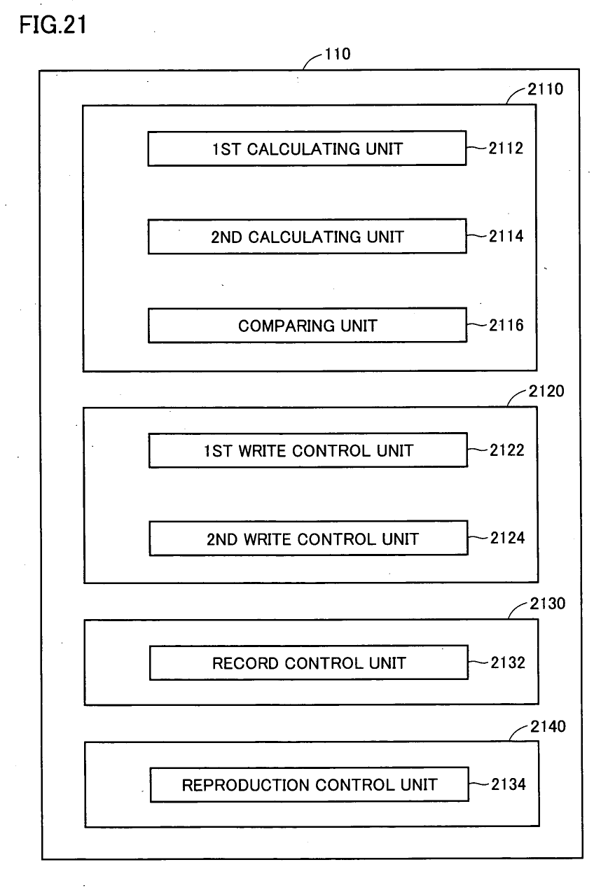

Referring to FIG. 21, system control circuit 110 includes a determining unit 2110 determining, based on record information, whether all the record mediums must store the picture and audio data or not, a first continuous record control unit 2120 writing control data, which represents that the picture and audio data are continuously stored on the plurality of record mediums, when it is determined that all the record mediums must store the picture and audio data, a second continuous record control unit 2130 controlling the data record/reproduction head to record continuously the picture and audio data on all the record mediums, and a continuous reproducing unit 2140 controlling, based on the control data, the data record/reproduction head to reproduce continuously the recorded picture and audio data.

Preferably, determining unit 2110 includes a first calculating unit 2112 calculating a capacity available for recording the picture and audio data on the first record medium according to the recording information, a second calculating unit 2114 calculating a capacity required for recording the picture and audio data according to the recording information, and a comparing unit 2116 comparing the available capacity with the required capacity.

First continuous record control unit 2120 includes a first write control unit 2122 controlling the data record/reproduction head to store first record information, which represents continuous storage of the picture and audio data, in a predetermined region on the record medium to be used first for storing the picture and audio data when the capacity required for recording exceeds the capacity available for recording. First continuous record control unit 2120 also includes a second write control unit 2124 controlling the data record/reproduction head to store second record information, which represents a storage location of the picture and audio data continued from the picture and audio data stored on the first record medium, on the second record medium when the capacity required for recording exceeds the capacity available for recording.

Second continuous record control unit 2130 includes a record control unit 2132, which switches the recording destination of the picture and audio data based on the recording information between the first and second record mediums based on the capacity required for recording and the capacity available for recording. Continuous reproducing unit 2140 includes a reproduction control unit 2134 includes a reproduction control unit 2134 controlling the data record/reproduction head to reproduce continuously the picture and audio data according to the first and second recording information.

The invention can be applied to the data record/reproduction devices each having a plurality of regions nonvolatilely storing the picture data, and can be applied, e.g., to devices provided with a magneto-optical disk recorder, a flash memory and others. In a certain aspect, the invention can be applied to devices provided with a plurality of record mediums, and can be applied, e.g., to a device with a hard disk and a DVD recorder, a device with a hard disk and a VTR, a device with a hard disk, a DVD recorder and a VTR. In another aspect, the invention can be applied to a device such as a hard disk recorder, in which a single record medium is divided into a plurality of regions for recording data in the respective regions.

Although the present invention has been described and illustrated in detail, it is clearly understood that the same is by way of illustration and example only and is not to be taken by way of limitation, the spirit and scope of the present invention being limited only by the terms of the appended claims.

1. A data record/reproduction device comprising:
first and second recording units for storing data;
a first writing unit writing the data to said first recording unit;
a first reproducing unit reading the data from said first recording unit;
a second writing unit writing the data to said second recording unit;
a second reproducing unit reading the data from said second recording unit;
a record information recording unit storing record information;
a determining unit determining based on said record information whether or not the data must be recorded on both of said first and second recording units;
a first continuous record control unit controlling said first and second writing units to write control data representing continuous recording of the data to said first and second recording units when said determining unit determines that both the recording units must record the data;
a second continuous record control unit controlling said first and second writing units to record continuously the data in said first and second recording units when said determining unit determines that the data must be recorded in both of said first and second recording units; and
a continuous reproducing unit controlling said first and second reproducing units to reproduce continuously the data based on said control data.

2. The data record/reproduction device according to claim 1, wherein
said determining unit includes:
a first calculating unit calculating a capacity available for recording the data by said first recording unit based on said record information,
a second calculating unit calculating a capacity required for recording the data based on said record information, and
a comparing unit comparing said capacity available for the recording and said required capacity;
said first continuous record control unit includes:
a first write control unit controlling said first writing unit to store first record information representing continuous storage of the data in said second recording unit in a predetermined region of said first recording unit when said capacity required for the recording exceeds said capacity available for the recording, and
a second write control unit controlling said second writing unit to store second record information representing a storage location of the data continued from the data stored in the first recording unit in said second recording unit;
said second continuous record control unit includes a record control unit switching a data record destination based on said record information between said first and second recording units based on said capacity required for the recording and said capacity available for the recording; and
said continuous reproducing unit includes a reproduction control unit controlling said first and second reproducing units to reproduce continuously the data stored in said first and second reproducing units based on said first and second record information, respectively.

3. The data record/reproduction device according to claim 2, wherein
when said capacity required for the recording exceeds said capacity available for the recording, said record control unit switches the record destination of the picture data based on said record information from said first recording unit to said second recording unit.

4. The data record/reproduction device according to claim 2, wherein
said record control unit controls said second writing unit to store the picture data in said second recording unit subsequently to the recording of the picture data in said first recording unit by said first writing unit.

5. The data record/reproduction device according to claim 2, wherein
said reproduction control unit controls said second reproducing unit to reproduce the data subsequently to the reproduction by said first reproducing unit based on said second record information when said reproduction control unit detects said first record information during reproduction of the data by said first reproducing unit.

6. The data record/reproduction device according to claim 2, wherein
said first calculating unit calculates, as said capacity, a time available for recording the picture data in said first recording unit, and
said second calculating unit calculates a time required for recording said picture data based on said record information.

7. The data record/reproduction device according to claim 2, wherein
said record information recording unit stores the record information for programmed recording,
said first calculating unit calculates a capacity available for recording the picture data in said first recording unit during execution of recording based on said record information, and
said second calculating unit calculates a capacity required for recording said picture data based on said record information during execution of recording based on said record information.

8. The data record/reproduction device according to claim 2, wherein
said record information recording unit stores the record information for programmed recording,
said first calculating unit calculates a capacity available for recording the picture data in said first recording unit before execution of the recording based on said record information, and
said second calculating unit calculates a capacity available for recording said picture data based on said record information before execution of the recording based on said record information.

9. The data record/reproduction device according to claim 2, wherein
said first calculating unit calculates an amount of recordable data as said capacity, and
said second calculating unit calculates an amount of the data to be recorded based on said record information.

10. The data record/reproduction device according to claim 2, further comprising:
an order data recording unit storing data representing priorities of the writing of data to said first and second recording units; and
a control unit controlling said first and second writing units to record the data according to said priorities.

11. The data record/reproduction device according to claim 10, further comprising:
an input unit receiving the data representing said priorities; and
a renewing unit storing the data representing the priorities received via said input unit in said order data recording unit.

12. The data record/reproduction device according to claim 2, wherein
one of said first and second recording units includes a removable data record medium.

13. The data record/reproduction device according to claim 2, wherein
one of said first and second recording units includes a magneto-optical record medium.

14. The data record/reproduction device according to claim 2, wherein
one of said first and second recording units includes a record medium electrically storing the data.

15. The data record/reproduction device according to claim 2, wherein
a data recording function of said first recording unit is the same as a data recording function of said second recording unit.

16. The data record/reproduction device according to claim 2, wherein
a data recording function of said first recording unit is different from a data recording function of said second recording unit.

17. The data record/reproduction device according to claim 2, further comprising:
a third recording unit storing the data;
a third writing unit writing the data to said third recording unit;
a third reproducing unit reading the data from said third recording unit;
an order storing unit storing order of writing the data in said first, second and third recording units; and
a control unit controlling said first, second and third writing units to record the data in said order.

18. The data record/reproduction device according to claim 17, wherein
said order of writing the data is predetermined.

19. The data record/reproduction device according to claim 17, further comprising:
a detecting unit detecting the recording unit inoperable to execute the recording in said order, wherein
when said detecting unit detects the recording unit inoperable to execute the recording in said order, said control unit controls the writing unit provided for writing the data in the recording unit having a next priority following the priority of the detected recording unit to write the data in the recording unit having said next priority.

20. A data record/reproduction device comprising:
a first recording unit storing picture data and information representing a record location of subsequent data to be recorded subsequently to said picture data;
a second recording unit storing information for identifying the picture data stored in said first recording unit and said subsequent data;
a first writing unit writing the data to said first recording unit;
a first reproducing unit reading the data from said first recording unit;
a second writing unit writing the data to said second recording unit;
a second reproducing unit reading the data from said second recording unit;
a record information recording unit storing the record information for programmed recording;
a first calculating unit calculating a time available for recording the picture data by said first recording unit during execution of the recording based on said record information;
a second calculating unit calculating a time required for recording said picture data based on said record information during execution of the recording based on said record information;
a comparing unit comparing said time available for the recording and said required time;
a first producing unit producing first record information representing subsequent storage of the picture data in said second recording unit when said required time exceeds said time available for the recording;
a first control unit controlling said first writing unit to write said first record information in a predetermined region of said first recording unit;
a producing unit producing second record information representing the location of said subsequent data in said second recording unit when said required time exceeds said time available for the recording, said subsequent data being data recorded subsequently to the picture data stored in said first recording unit;
a second control unit controlling said second writing unit to write said second record information in a predetermined region of said second recording unit;
a write control unit controlling said second writing unit to record the picture data in said second recording unit subsequently to the recording of the picture data in said first recording unit by said first writing unit when said required time exceeds said time available for the recording; and
a reproduction control unit controlling said second reproducing unit to reproduce the picture data subsequently to the reproduction by said first reproducing unit based on said second record information when said first record information is detected during reproduction of the picture data by said first reproducing unit.
